(19) United States
(12) Patent Application Publication
(10) Pub. No.: US 2019/0010065 A1
(43) Pub. Date: Jan. 10, 2019

(54) PROCESS FOR PRODUCING A PHOSPHORUS PRODUCT FROM WASTEWATER

(71) Applicant: KEMIRA OYJ, HELSINKI (FI)

(72) Inventors: Fazlollah AZARNOUSH, ESPOO (FI); Outi GRÖNFORS, ESPOO (FI); Roger BÅRSTRÖM, ESPOO (FI); Bengt HANSEN, ESPOO (FI); Joonas LIKANDER, ESPOO (FI); Petteri SUOMINEN, ESPOO (FI)

(21) Appl. No.: 16/064,002

(22) PCT Filed: Dec. 21, 2016
(86) PCT No.: PCT/EP2016/082152

§ 371 Date: Jun. 19, 2018

(30) Foreign Application Priority Data
Dec. 21, 2015 (FI) 20155979

(51) Int. Cl. C02F 1/52; C01B 25/30; C01B 25/36; C01B 25/32; C01B 25/26; C05B 7/00; C05B 3/00; C05B 17/00; C05F 7/00

(52) U.S. Cl. CPC C02F 1/5245; C01B 25/30; C01B 25/36; C01B 25/32; C02F 2101/105; C05B 7/00; C05B 3/00; C05B 17/00; C05F 7/005; C01B 25/265

(57) ABSTRACT

The present invention concerns a process for producing a high purity phosphorus product from wastewater, by carrying to the process phosphate-containing wastewater that has been treated to remove biomass and other impurities, not including dissolved phosphates, creating floes using one or more iron, aluminium, magnesium or calcium salts, adding an alkali metal or alkaline earth metal hydroxide or oxide to the flocs in an amount effective to react the iron, aluminium, magnesium or calcium salt into the corresponding hydroxide, separating the hydroxide from the formed phosphate, and obtaining the high purity phosphorus product in a form of a liquid or solid phosphate salt.

### FIELD OF THE INVENTION

The present invention concerns a process for producing a phosphorus product from wastewater.

### BACKGROUND

Municipal wastewater contains a lot of different substances. The most commonly used parameters comprise biochemical oxygen demand (BOD), suspended solids (SS), phosphorus (P) and nitrogen (N). These parameters are typically regulated by authorities.

Municipal wastewater treatment processes typically include several steps, all designed to provide water that is sufficiently clean for returning to water streams. These process steps may include
mechanical, optionally with added inorganic chemical, designed to separate suspended solids and possibly phosphorus from raw sewage for example in sedimentation basins,
biological, designed to consume organic matter using microbes, preferably followed by a further sedimentation step designed to further separate suspended solids, and
nutrient removal, which can be a part of the biological process or done by chemical treatment.

### SUMMARY OF THE INVENTION

It is an object of the present invention to provide a process for producing a phosphorus product from wastewater, preferably a high purity product. The process in accordance with embodiments of the invention is particularly suitable as a post-treatment step for a wastewater treatment process in which a maximum amount of phosphorus is kept as dissolved phosphorus in the water phase through a wastewater treatment process until the post-treatment step.

Particularly, it is an object of the present invention to provide a process, wherein the phosphorus can be separated from the wastewater in a form of a liquid or solid phosphate salt.

These and other objects, together with the advantages thereof over known processes, are achieved by the present invention, as hereinafter described and claimed.

The present invention concerns a process for producing a high purity phosphorus product from wastewater, which has been treated to remove biomass and other impurities, such as suspended solids. The phosphorus is precipitated as metal phosphate, with the help of metal salt(s), such as iron or aluminium salts. The recovered phosphorus will then typically be in the form of Na₃PO₄.nH₂O crystals or calcium phosphate salts, such as Ca₃(PO₄)₂ or CaHPO₄ that can be used as fertilizer.

More specifically, the process of the present invention is characterized by what is stated in the attached claims.

In the present process, wastewater to be carried to the process is first treated to remove biomass and other impurities, but a maximum amount of phosphorus is kept as dissolved phosphorus in the water phase through the wastewater treatment process until a post-treatment step. In accordance with embodiments of invention, the dissolved phosphorus can be precipitated from the phosphate-containing wastewater and the resulting phosphate salt can be separated with a high purity since most of the other impurities have been removed from the water in the first previous steps.

Embodiments of a suitable process for treating the wastewater to be carried to the post-treatment process in accordance with embodiments of the invention are described in a simultaneously filed patent application with the title “Recovery of Phosphorus Compounds from Wastewater”.

The high purity phosphorus product that is produced according to the present invention is low in heavy metals and low in organics. The phosphorus recovery rate in the present process is typically about 70-95% of the phosphorus in the treated wastewater coming into the post-treatment process.

As the phosphorus is separated from water, and not precipitated into the sludge with the suspended solids of the incoming wastewater, advantage for a wastewater treatment plant is reduced sludge volumes. Lower sludge volumes result also in decreased need of sludge treatment or disposal. Furthermore, separating phosphorus from water is much more efficient, easier and less energy consuming than when separating it from the sludge or even after sludge treatment processes, such as incineration and separation from ash with high chemical consumption, such as in extraction.

An object of the present invention is to provide a process for producing a phosphorus product from wastewater, the process comprising:
a) carrying to the process phosphate-containing wastewater that has been treated to remove biomass and other impurities, not including dissolved phosphates,
b) creating phosphate-containing flocs from the treated wastewater using at least one metal salt selected from the group iron, magnesium, calcium and aluminium salts,
c) adding an alkali metal or alkaline earth metal hydroxide or oxide to the flocs in an amount effective to react said metal salt into the corresponding hydroxide,
d) separating the hydroxide from the formed phosphate of step c), and
e) obtaining the phosphorus product in a form of a liquid or solid phosphate salt.

According to one embodiment the phosphate-containing flocs may be separated from the remaining treated wastewater by using a physical separation step, e.g. being selected from sedimentation, flotation, centrifugation and filtration. The physical separation step may be performed by using a device selected from disk filter, chamber filter press, decanter centrifuge, and hydrocyclone.

According to one embodiment said iron salt may be selected from the group iron sulphates and chlorides, and any combination thereof, such as selected from the group ferric chloride, ferric sulphate, ferric chlorosulphate, ferrous chloride, ferrous chlorosulphate and ferrous sulphate, and any combination thereof, whereby the main reaction of step b) will result in the formation of iron phosphate (FePO₄). Ferric chloride is a preferred compound.

According to one embodiment said aluminium salts may be selected from the group aluminium sulphates, nitrates, chlorohydrates and chlorides, and any combination thereof, such as selected from the group aluminium sulphate, aluminium chloride, aluminium chlorohydrate and polyaluminium compounds, and any combination thereof, whereby the main reaction of step b) will result in the formation of aluminium phosphate (AlPO₄). The polyaluminium compound may be selected from polyaluminium chloride, polyaluminium sulphate, and polyaluminium nitrate; and preferably is a polyaluminium chloride (Alₙ(OH)ₘCl₍₃ₙ₋ₘ₎)ₓ).

According to one embodiment the alkali metal or alkaline earth metal hydroxide or oxide used in step c) may be selected from the group consisting of sodium hydroxide, potassium hydroxide, magnesium oxide (MgO), magnesium hydroxide (Mg(OH)₂) and calcium oxide (CaO), calcium hydroxide (Ca(OH)₂), and any combination thereof.

According to one embodiment the sodium hydroxide (NaOH) may be provided in a concentration of 10-60 wt %, preferably 30-50 wt %, or provided in the form of dry NaOH pellets.

According to one embodiment the potassium hydroxide (KOH) may be provided in a concentration of 30-60 wt %, preferably 40-50 wt %.

According to one embodiment the phosphorus salt obtained in step e) may be crystallized as Na₃PO₄.nH₂O crystals from a Na₃PO₄ liquid, or an aqueous K₃PO₄ liquid obtained in step e) may be subjected to evaporation to obtain a pure K₃PO₄ liquid.

According to one embodiment phosphate may be crystallized from a Na₃PO₄ liquid obtained in step e) by decreasing the temperature to ≤50° C., such as ≤25° C., ≤15° C., or ≤5° C.

According to one embodiment the phosphate salt obtained in step e) may be reacted further, preferably by providing Na₃PO₄.nH₂O crystals and reacting them into calcium phosphate (Ca₃(PO₄)₂) by adding calcium hydroxide (Ca(OH)₂) or calcium oxide (CaO), or reacting the calcium phosphate even further to calcium hydrogen phosphate (CaHPO₄) by adding sulphuric acid (H₂SO₄).

According to one embodiment sodium hydroxide created in the reaction, when adding the calcium hydroxide or calcium oxide, may be recycled to step c) and used as the alkali metal hydroxide.

According to one embodiment the precipitated iron hydroxide optionally obtained in step c), may be converted to ferric chloride using HCl or H₂SO₄ or HNO₃, and recycled to step b).

According to one embodiment sodium aluminate NaAl(OH)₄ optionally produced in step c) from AlPO₄ may be used as a coagulant for wastewater treatment application.

According to one embodiment the phosphorus product may have a heavy metal content of at most 10 mg/kg, such as 5 mg/kg; and/or an organics content of at most 1 wt %, such as 0.5 wt %.

An object of the present invention is to provide a fertilizer or fertilizer raw material comprising a phosphorus product obtained by the present process.

An object of the present invention is to provide use of a phosphorus product obtained by the present process as a fertilizer or fertilizer raw material.

Next, the invention will be described more closely with reference to the attached drawings and a detailed description.

### BRIEF DESCRIPTION OF THE DRAWINGS

FIG. 1 is a schematic diagram of a process scheme that can be used to obtain the wastewater fed to the present process.

FIG. 2 is a schematic diagram of an alternative process scheme that can be used to obtain the wastewater fed to the present process.

FIG. 3 is a schematic diagram of another alternative process scheme that can be used to obtain the wastewater fed to the present process.

FIG. 4 is a schematic diagram of a further alternative process scheme that can be used to obtain the wastewater fed to the present process.

FIG. 5 is a schematic diagram of the process scheme used for the post-treatment process in an embodiment of the present invention.

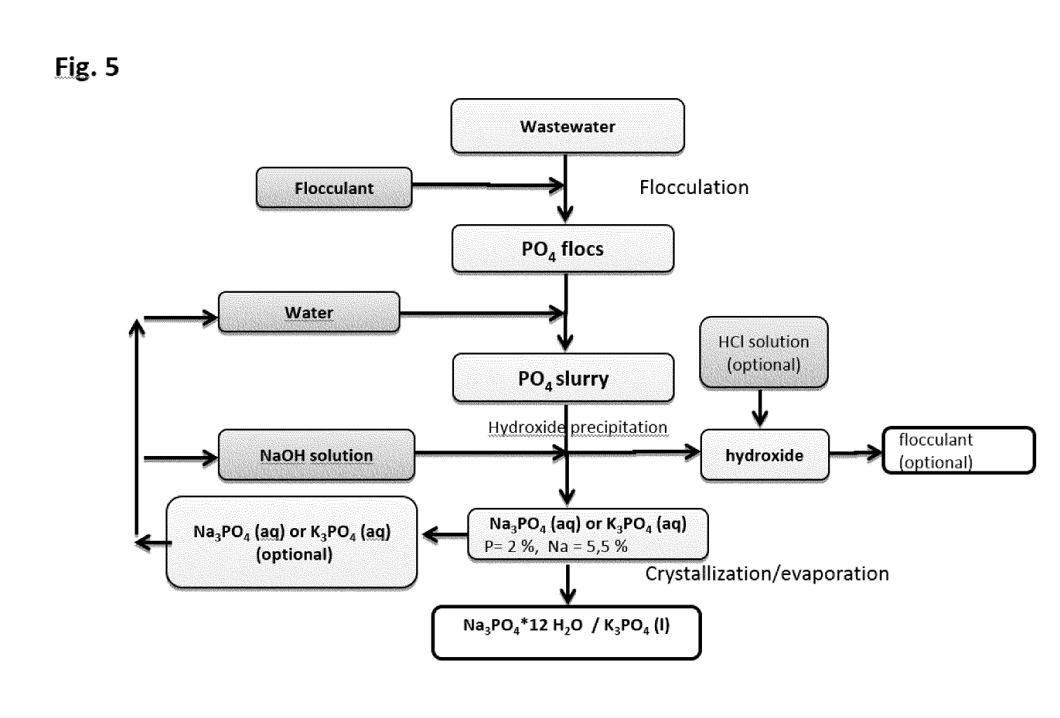

FIG. 6 is a schematic diagram of the process scheme used for the post-treatment process in another embodiment of the present invention.

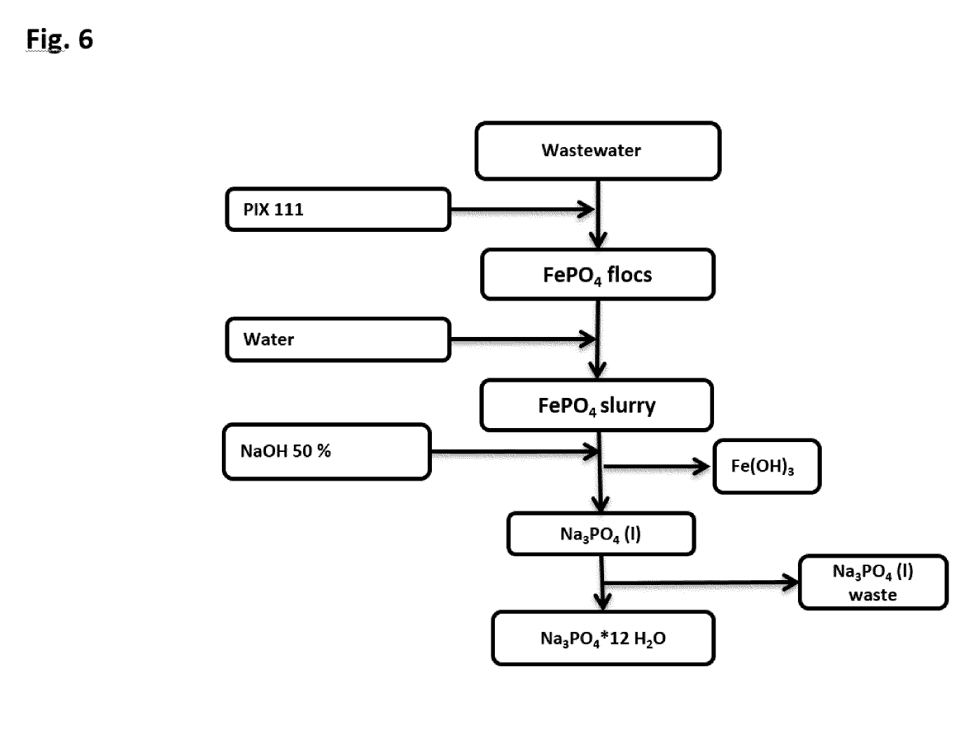

FIG. 7 is a schematic diagram of the process scheme used for the post-treatment process in a third embodiment of the present invention.

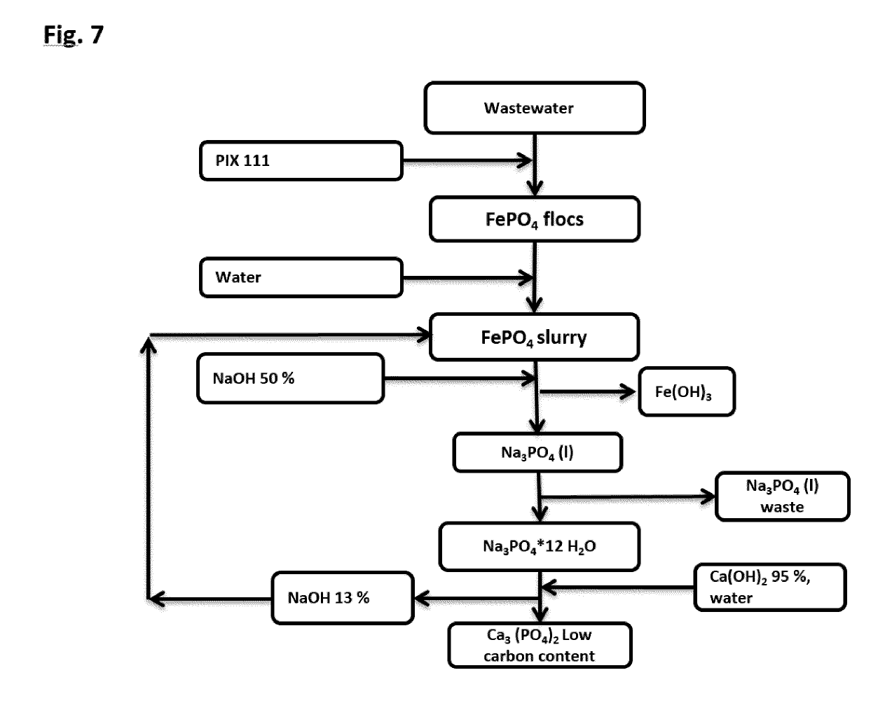

FIG. 8 is a schematic diagram of the process scheme used for the post-treatment process in a fourth embodiment of the present invention.

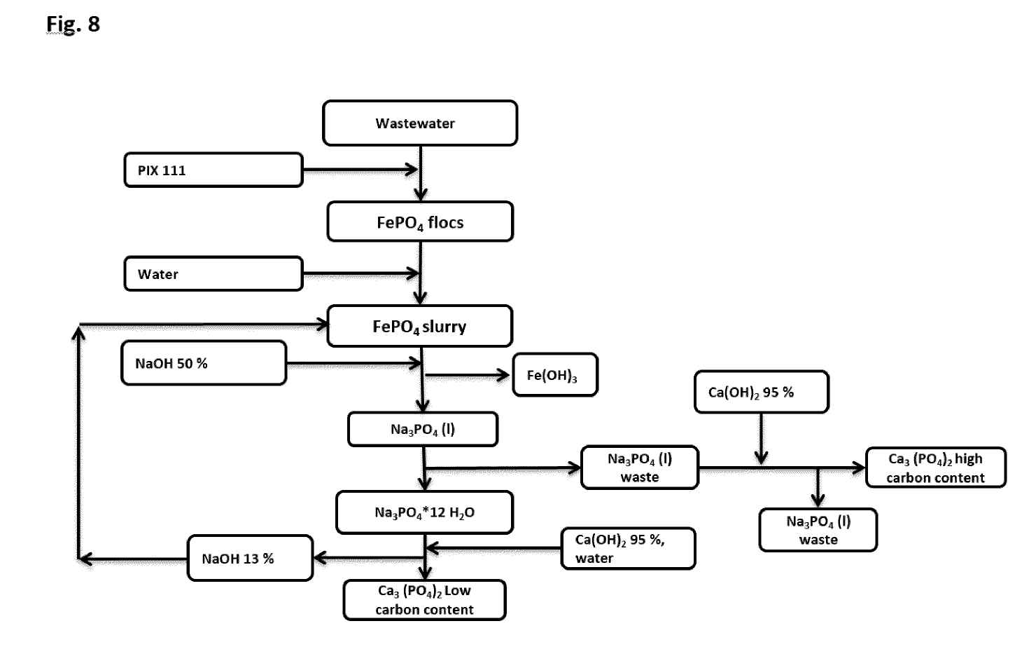

### DETAILED DESCRIPTION OF EMBODIMENTS OF THE INVENTION

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

In embodiments of the invention, phosphorus is separated from the phosphate-containing wastewater in a post-treatment process, wherein the wastewater being carried to the process has been treated to remove biomass and other impurities, not including phosphates, from the wastewater. According to an embodiment of the invention, the post-treatment process includes the following sub-steps:
a) carrying said treated wastewater to the present post-treatment,
b) flocculation,
c) hydroxide or oxide addition,
d) separation of the resulting hydroxide,
e) obtaining a high purity phosphorus product in a form of a phosphate salt.

In one embodiment, one or more metal salts, such as iron, magnesium, calcium or aluminium salts, are used to flocculate the phosphorus in step b).

In one embodiment, the one or more metal salts may be selected from iron salts, such as chlorides and/or sulphates thereof, e.g. ferric chloride, ferric sulphate, ferric chlorosulphate, ferrous chloride, ferrous chlorosulphate and ferrous sulphate. Preferably ferric chloride (FeCl₃) is used. The main reaction (1) in this step b) will result in the formation of iron phosphate.

Fe³⁺+HₙPO₄³⁻ⁿ↔FePO₄+nH⁺

In one embodiment, the one or more metal salts may be selected from aluminium salts, and result in the formation of aluminium phosphate (AlPO₄) in the flocculation step b). The aluminium salts may be sulphates, nitrates, chlorohydrates and chlorides, and any combination thereof. Examples of aluminium salts may be selected from the group aluminium sulphate, aluminium chloride, aluminium chlorohydrate and polyaluminium compounds, and any combination thereof. Polyaluminium compounds may be selected from polyaluminium chloride, polyaluminium sulphate, and polyaluminium nitrate, e.g. preferably polyaluminium chloride (Aln(OH)mCl(3n-m))x).

In one embodiment, the one or more metal salts may be selected from calcium or magnesium salts, such as calcium chloride, calcium sulphate, magnesium sulphate or magnesium chloride.

During flocculation, gentle mixing accelerates the rate of particle collision, and the destabilized particles are further aggregated and enmeshed into larger precipitates. Flocculation is affected by several parameters, including mixing speeds, mixing intensity, and mixing time. The product of the mixing intensity and mixing time is used to describe the flocculation process.

The separation of the flocs from this treated wastewater typically takes place by sedimentation or flotation. The obtained deflocculated wastewater can then be treated further, or it can be discarded as cleaned wastewater.

According to an embodiment, the flocculation step b) is followed by:
c) reacting the phosphate (PO₄) flocs using an alkali metal hydroxide or oxide to obtain Na₃PO₄ or K₃PO₄, typically in liquid (or aqueous) form.

According to an embodiment, the phosphate salt is obtained by:
crystallizing the phosphorus as Na₃PO₄.nH₂O crystals from the Na₃PO₄ liquid, or subjecting the K₃PO₄ liquid to evaporation.

According to one embodiment of the invention, the alkali metal hydroxide used in step c) is selected from sodium hydroxide (NaOH) and potassium hydroxide (KOH), particularly in an amount and concentration that will maintain a pH of 13:

FePO₄(s)+3NaOH→Na₃PO₄(l)+Fe(OH)₃(s)

FePO₄(s)+3H₂O+3KOH→K₃PO₄(l)+Fe(OH)₃(s), or

AlPO₄(s)+4NaOH→Na₃PO₄(l)+NaAlOH₄(l) (2)

The NaOH is typically used in a concentration of 10-50 w-%, particularly a concentration of 30-50 w-%. Alternatively, NaOH pellets are used, as these reduce the amount of external added water in the process, and a more concentrated phosphorus product can be obtained. Any liquid needed in the process can, according to an embodiment, be added in the form of recycled NaOH, obtained from step d) of this post-treatment.

When using KOH, it is in turn typically added in a concentration of 30-60 w-%.

The crystallization and evaporative crystallization of the phosphate from the Na₃PO₄ liquid obtained in one version of step d) can, according to an embodiment, take place by decreasing the temperature to ≤50° C., preferably ≤25° C., more preferably ≤15° C., and most suitably ≤5° C. The recovered phosphorus will then be in the form of sodium phosphate salt, suitable for use e.g. as fertilizer or fertilizer raw material.

According to another version, the phosphate salt is obtained from an aqueous K₃PO₄ solution by evaporation to give a K₃PO₄ salt. Due to the high solubility of this potassium phosphate, the salt will still be in liquid form (P=1.6% and K=4.6%).

The obtained phosphate salts can subsequently be dewatered by physical means, for example via a physical separation step, which may be exemplified any one of by sedimentation, flotation, centrifugation and filtration. Examples of suitable devices for such a physical separation are e.g. any one of disk filter, chamber filter press, decanter centrifuge, and hydrocyclone. The obtained phosphate salts can be dewatered by a chemical-physical separation step, which may be exemplified by adsorption and/or ion exchange, to be used to separate the phosphate salts. Adsorption or ion exchange separation is preferably done without flocculation first, as phosphate ions present in the water are adsorped or reacted with ion exchange material. If phosphate-containing flocs are obtained in the process, an acid treatment may be performed to allow separation using adsorption or ion exchange. The physical and chemical-physical separations may be used alone or in combination.

As an optional further step d), the phosphate salts obtained in step d) can be reacted further into different salts. For example, Na₃PO₄.nH₂O crystals can be treated further to calcium phosphate (Ca₃(PO₄)₂) by adding calcium hydroxide (Ca(OH)₂) or calcium oxide (CaO), or even further to calcium hydrogen phosphate (CaHPO₄) by adding sulphuric acid (H₂SO₄).

Furthermore, to provide a more efficient process, the iron hydroxide (Fe(OH)₃) precipitates optionally obtained in step c) can be treated further by HCl or H₂SO₄ or HNO₃ to form the iron coagulants, e.g. ferric chloride (FeCl₃) or ferric nitrate or ferric sulphate. The formed coagulants can be recycled back to the above described step b) of the present process or used in other wastewater treatment applications. Also sodium aluminate NaAl(OH)₄ produced from AlPO₄ can be used as a coagulant for wastewater treatment applications. NaAl(OH)₄ may also be called sodium tetrahydroxyaluminate.

The process can be optimized using recycled liquid from the process.

The present invention relates to providing a high purity phosphorous product. The obtained product is of high purity due to the low content of contaminants, such as heavy metals and organics, therein. The phosphate salt obtained in embodiments of the invention typically has a low content of other contaminants than what can be achieved by recovering phosphorus from wastewater sludges. The phosphate salt obtained in accordance with the embodiments of the invention is low in heavy metals and low in organics, i.e. organic materials, and can be used directly for example as a fertilizer. The present invention thus may provide a fertilizer comprising the phosphorus product obtained by the present process. Typically, Fe level is ≤10 mg/kg and heavy metals such as Ni, Cr, Co, Cu, Mn, ≤10 mg/kg, more typically ≤5 mg/kg. The organics are typically in a form of organic carbon and the concentrations of organic is typically ≤1 wt %, more typically ≤0.5 wt % and most typically ≤0.1 wt %. The high purity phosphorous product obtainable by the present process may have a heavy metal content of at most 10 mg/kg (10 ppm), such as 5 mg/kg (5 ppm), and/or an organics content of at most 1 wt % (10 000 ppm), such as at most 0.5 wt % (5 000 ppm), at most 0.1 wt % (1 000 ppm), at most 0.05 wt % (500 ppm), at most 0.022 wt % (220 ppm), or at most 0.01 wt % (100 ppm).

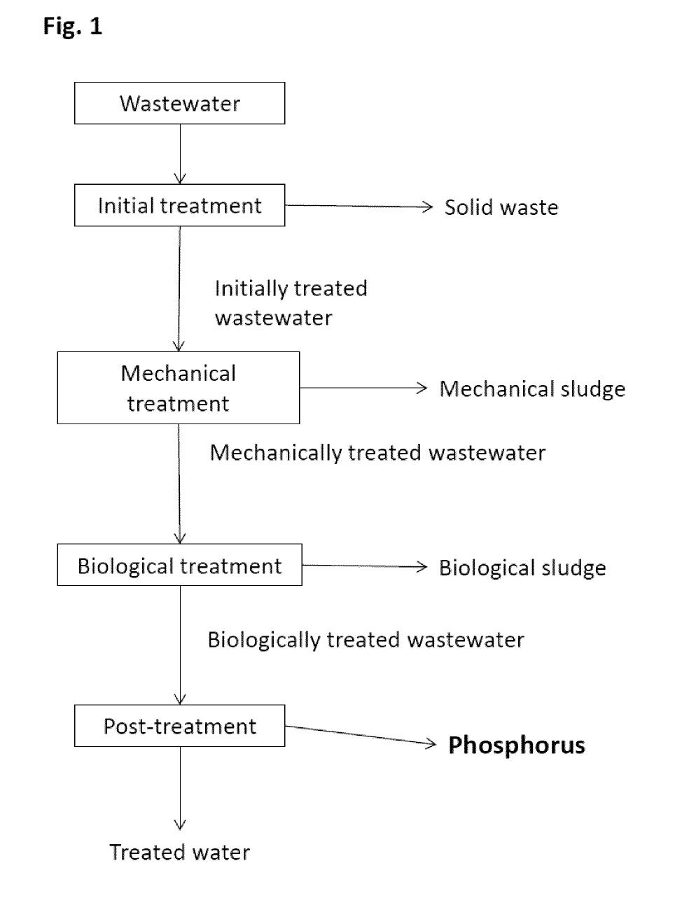

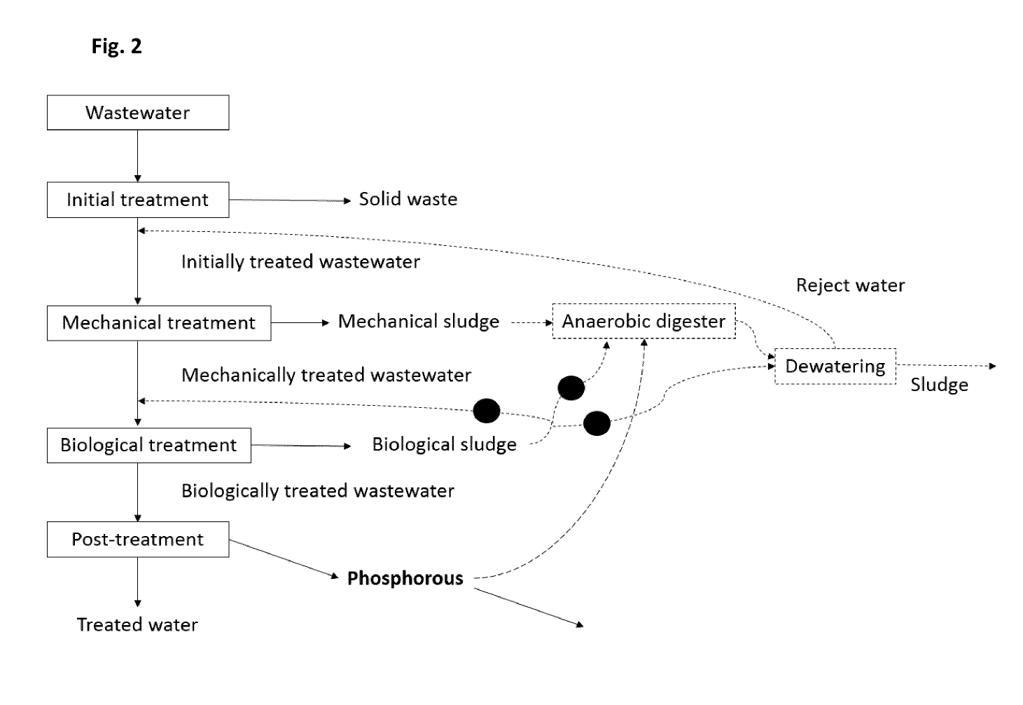

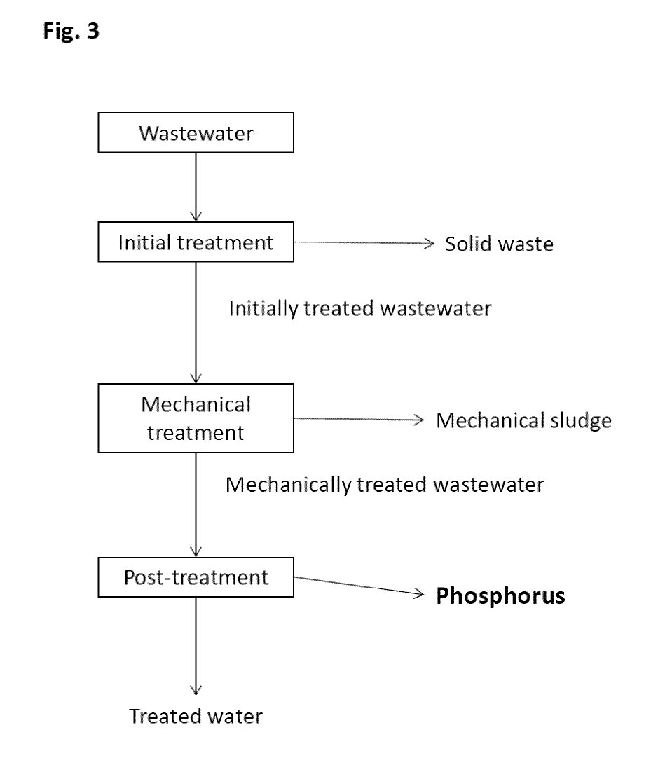

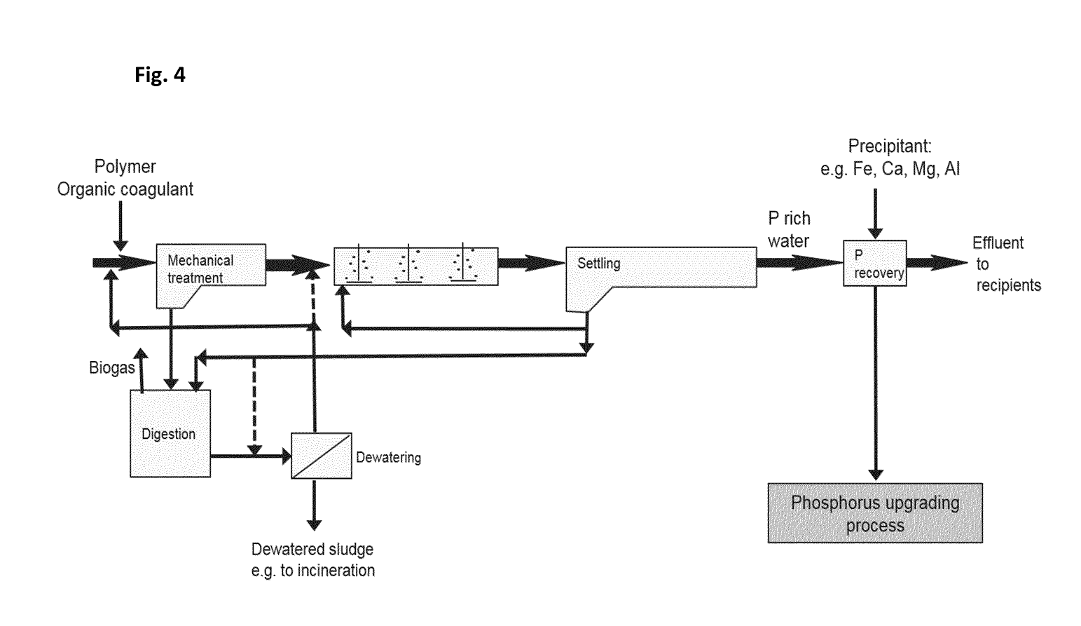

According to a preferred embodiment, the present process producing a high purity phosphorus product from wastewater includes the steps of (see FIGS. 1-4)
carrying to the process phosphate-containing wastewater that has been treated to remove biomass and other impurities, not including dissolved phosphates,
creating phosphate-containing flocs from the treated wastewater using one or more metal salts, such as iron or aluminium salts,
adding an alkali metal hydroxide or oxide to the flocs in an amount effective to react the metal salt into the corresponding hydroxide,
separating the hydroxide from the phosphate formed in the previous step, and
obtaining the high purity phosphorus product in a form of a liquid or solid phosphate salt.

The following non-limiting examples are intended merely to illustrate the advantages obtained with the embodiments of the present invention.

### EXAMPLES

1. In the following examples dry ferric phosphate was used which was precipitated by adding 0.2 kg ferric chloride in 1 m³ wastewater. Ferric phosphate was separated by filtration (Buchnerfilter) and was dried in oven at 50° C. for 24 hours.
2. Slurry was prepared by mixing 20 g of dry ferric phosphate with 100 g water. The slurry was treated with 24 g sodium hydroxide (50%) at 50° C. for half hour. The reaction mixture was filtered giving 13 g ferric hydroxide as dry. The filtered solution was cooled down to 7° C. and 10 g trisodium phosphate as dry was crystallized and separated by filtration. Trisodium phosphate crystals had the following composition: P=16.8%, Na=36.1%. Trisodium phosphate crystals contained 0.1% carbon and less than 10 mg/l iron and other toxic metals.
3. 10 g dry sodium phosphate from Example 2 were treated with 6 g calcium hydroxide (96%) and 80 g water at 50° C. and for 1 hour. 10 g calcium phosphate as dry was precipitated and separated from the reaction mixture by filtration. The calcium phosphate had the following composition: P=12.5%, Ca=31%, Na=2.7%. The calcium phosphate contained 120 mg/kg organic and less than 10 mg/kg iron and other toxic metals.
4. The mother liquid in Example 2 (P=0.15%) was treated with 6 g calcium hydroxide (96%) per kg mother liquid at 50° C. for 1 hour. 24 g calcium phosphate as dry per kg mother liquid was precipitated and separated by filtration. The calcium phosphate had the following analysis: P=13.3%, Ca=30.8%, Na=0.2%. The calcium phosphate contained 1% organic and low amount of iron and other toxic metal (less than 10 mg/kg). The yield of phosphorus recovery using Examples 2 to 4 is 91.7%.
5. Slurry was prepared by mixing 20 g dry ferric phosphate with 100 g water. The slurry was treated with 26 g potassium hydroxide (50%). 15 g ferric hydroxide as dry was separated by filtration from the reaction mixture and the liquid potassium phosphate was produced with the following analysis P=1.6% and K=4.6%.
6. Solid alumininum phosphate was precipitated by adding alumininum sulphate to sodium phosphate solution at pH 7. Alumininum phosphate was separated by filtration and was dried in oven at 50° C. for 24 hours. Slurry was prepared by mixing 30 g dry alumininum phosphate with 130 g water. The slurry was treated with 27 g sodium hydroxide (50%) at 50° C. for 0.5 hour. 20 g trisodium phosphate as dry was crystallized and separated by filtration when the mother liquid was cooled to the 7° C. Trisodium phosphate crystals contained 2% aluminium, 8% phosphorus and 27% sodium.

1. A process for producing a phosphorus product from wastewater, the process comprising:
a) carrying to the process phosphate-containing wastewater that has been treated to remove biomass and other impurities, not including dissolved phosphates,
b) creating phosphate-containing flocs from the treated wastewater using at least one metal salt selected from the group iron, magnesium, calcium and aluminium salts,
c) adding an alkali metal or alkaline earth metal hydroxide or oxide to the flocs in an amount effective to react said metal salt into the corresponding hydroxide,
d) separating the hydroxide from the formed phosphate of step c), and
e) obtaining the phosphorus product in a form of a liquid or solid phosphate salt.

2. The process according to claim 1, wherein the phosphate-containing flocs are separated from the remaining treated wastewater by using a physical separation step, preferably the physical separation step being selected from sedimentation, flotation, centrifugation and filtration, preferably the physical separation step is performed by using a device selected from disk filter, chamber filter press, decanter centrifuge, and hydrocyclone.

3. The process according to claim 1 or 2, wherein said iron salt is selected from the group iron sulphates and chlorides, and any combination thereof; preferably selected from the group ferric chloride, ferric sulphate, ferric chlorosulphate, ferrous chloride, ferrous chlorosulphate and ferrous sulphate, and any combination thereof; preferably ferric chloride; whereby the main reaction of step b) will result in the formation of iron phosphate.

4. The process according to claim 1, wherein said aluminium salts are selected from the group aluminium sulphates, nitrates, chlorohydrates and chlorides, and any combination thereof; preferably selected from the group aluminium sulphate, aluminium chloride, aluminium chlorohydrate and polyaluminium compounds, and any combination thereof; wherein the polyaluminium compound preferably is selected from polyaluminium chloride, polyaluminium sulphate, and polyaluminium nitrate, more preferably a polyaluminium chloride (Alₙ(OH)ₘCl₍₃ₙ₋ₘ₎)ₓ), whereby the main reaction of step b) will result in the formation of aluminium phosphate.

5. The process according to claim 1, wherein the alkali metal or alkaline earth metal hydroxide or oxide used in step c) is selected from the group consisting of sodium hydroxide, potassium hydroxide, magnesium oxide, magnesium hydroxide and calcium oxide, calcium hydroxide, and any combination thereof.

6. The process according to claim 5, wherein sodium hydroxide is provided in a concentration of 10-60 wt %, preferably 30-50 wt %, or provided in the form of dry NaOH pellets.

7. The process according to claim 5, wherein potassium hydroxide is provided in a concentration of 30-60 wt %, preferably 40-50 wt %.

8. The process according to claim 1, wherein the phosphorus salt obtained in step e) is crystallized as Na₃PO₄.nH₂O crystals from a Na₃PO₄ liquid, or an aqueous K₃PO₄ liquid obtained in step e) is subjected to evaporation to obtain a pure K₃PO₄ liquid.

9. The process according to claim 1, wherein phosphate is crystallized from a Na₃PO₄ liquid obtained in step e) by decreasing the temperature to ≤50° C., preferably ≤25° C., more preferably ≤15° C., and most suitably ≤5° C.

10. The process according to claim 1, wherein the phosphate salt obtained in step e) is reacted further, preferably by providing Na₃PO₄.nH₂O crystals and reacting them into calcium phosphate by adding calcium hydroxide or calcium oxide, or reacting the calcium phosphate even further to calcium hydrogen phosphate by adding sulphuric acid.

11. The process according to claim 10, wherein sodium hydroxide created in the reaction, when adding the calcium hydroxide or calcium oxide, is recycled to step c) and used as the alkali metal hydroxide.

12. The process according to claim 1, wherein the precipitated iron hydroxide optionally obtained in step c), is converted to ferric chloride using HCl or H₂SO₄ or HNO₃, and recycled to step b).

13. The process according to claim 1, wherein sodium aluminate NaAl(OH)₄ optionally produced in step c) from AlPO₄ is used as a coagulant for wastewater treatment application.

14. The process according to claim 1, wherein the phosphorus product has a heavy metal content of at most 10 mg/kg, preferably 5 mg/kg; and/or an organics content of at most 1 wt %, preferably 0.5 wt %.

15. Fertilizer or fertilizer raw material comprising a phosphorus product obtained by the process according to claim 1.

16. Use of a phosphorus product obtained by the process according to claim 1 as a fertilizer or fertilizer raw material.
